(19) United States
(12) Patent Application Publication
(10) Pub. No.: US 2009/0048905 A1
(43) Pub. Date: Feb. 19, 2009

(54) Methods for Grouping, Targeting and Meeting Objectives for an Advertisement Campaign

(76) Inventors: Xin Feng, Sunnyvale, CA (US); Srinivasa Dharmaji, Sunnyvale, CA (US)

Correspondence Address: GLENN PATENT GROUP, 3475 EDISON WAY, SUITE L, MENLO PARK, CA, 94025, US

(21) Appl. No.: 12/191,086

(22) Filed: Aug. 13, 2008

Related U.S. Application Data
(60) Provisional application No. 60/935,520, filed on Aug. 16, 2007.

(51) Int. Cl. G06Q 30/00

(52) U.S. Cl. 705/10; 705/14

(57) ABSTRACT

Targeted advertising is one of the major attractions of wireless handheld devices since it lends itself to focused delivery of advertisements to target groups selected based on multiple criteria. To do this it is necessary to identify the target groups from the large number of personal profile criteria that includes user profiles, demographics, response preferences, as well as the history of responses, and generating advertisements for each such group. The advertisements have to take into account the preferences of the group and the objective of the advertisement campaign. In one embodiment of the invention, target groups are identified based on preferences to define and organize advertising campaigns, resulting in personalized advertisements.

### CROSS REFERENCE TO RELATED APPLICATIONS

This patent application claims the benefit of U.S. provisional patent application Ser. No. 60/935,520, Methods for Grouping, Targeting and Meeting Objectives for an Advertisement Campaign, filed Aug. 16, 2007, the entirety of which is hereby incorporated by this reference thereto.

### BACKGROUND OF THE INVENTION

1. Technical Field

This invention generally relates to the grouping of users of wireless handheld devices into targeted customer groups. More specifically, this invention relates to the identification and classification of the viewing audience into specific target groups using a number of criteria such that targeted advertisements can be generated and delivered to the target audience for each advertising campaign.

2. Description of the Related Art

Hand-held devices, such as, e.g. cell phones, personal digital assistants (PDAs), hand-held video game devices, etc. typically transmit data using wireless communications. These devices can be physically connected to the network; however, this drastically reduces the portability of these devices.

Handheld devices can display advertisements. For example, a broadcast operator may place an advertisement at the beginning of a video clip, i.e. a preroll that the user must watch before viewing the selected video. The broadcast operator places the advertisements in a content data stream in an encoded format and sends the data stream to an internet service provider (ISP), e.g. Verizon® and AT&T®, for local transmission and coverage.

The data stream contains a number of time slots with fixed bandwidths that are made available to the local mobile operator to add their targeted advertisements. The bandwidths of these time slots are limited. Hence only a few advertisements can be transmitted in the advertisement slot provided, thereby resulting in insufficient coverage of targeted groups. This method limits the use of unique targeting criteria and the use of combining advertisements with the advertisement campaign requirements as a means for developing advertisements that are focused on the uniqueness of each target group to achieve maximum impact.

The multicast nature of the present day transmission also limits the ability of the data stream to carry selective sets of advertisements specific to different target groups within a transmission coverage area.

It would therefore be advantageous to provide a method, system, and apparatus that enable efficient and effective grouping of users of wireless handheld devices and more particularly, to send targeted advertising to these groups based on predefined criteria.

### SUMMARY OF THE INVENTION

The invention comprises a method and/or apparatus for identifying criteria for grouping wireless customers into target customer groups for targeted delivery of focused advertisement for optimum impact. In another embodiment, the invention comprises a method and/or apparatus for identifying criteria for developing advertisements matching the unique characteristics of target groups to enable focused advertisement delivery to specific target groups for maximum impact during an advertising campaign.

### BRIEF DESCRIPTION OF THE DRAWINGS

FIG. 1 is a block diagram that illustrates a system for implementing targeted advertising according to one embodiment of the invention;

FIG. 2 is a block diagram that illustrates one embodiment of a system for implementing targeted advertising on a handheld device;

FIG. 3 is a diagram that shows the criteria for defining the target group according to one embodiment of the present invention;

FIG. 4 is a diagram that shows the criteria for development of ads for specific target groups according to one embodiment of the invention; and

FIG. 5 is a flowchart that illustrates the steps of generating targeted advertising according to one embodiment of the invention;

### DETAILED DESCRIPTION OF THE INVENTION

Wireless handless devices are the perfect medium for targeted advertising because they can focus delivery of advertisements to target groups selected based on multiple criteria. To selectively target groups of handheld device users, users are categorized according to their personal profile criteria, which includes user profiles, demographics, response preferences, as well as the history of responses. The advertisements are tailored according to the preferences of the group and the objective of the advertisement campaign. In one embodiment of the invention, target groups are identified based on preferences, and advertisements are personalized for the target groups. In another embodiment of the invention, an advertising campaign is organized and defined according to advertisements personalized for target groups.

A common goal for advertisers in creating an advertising campaign is to develop a campaign that meets all the campaign objectives while focusing on individuals with specific characteristics. This requires identifying unique characteristics of individuals and defining target groups according to these characteristics based on the historic and demographic information available.

In the past, the multicast nature of the broadcast transmission limited the ability to deliver a large number of focused advertisements to a large number of target groups simultaneously. Hence targeting, even when done, was of a limited nature. This has changed with the delivery capabilities being developed and those disclosed in a co-pending U.S. provisional patent application No. 60/960,330, “Targeted Advertisement Transmission and Delivery in a Bandwidth Limited Multicast Wireless System,” filed Sep. 25, 2007 and assigned to common assignee, the contents of which are herein incorporated in their entirety by this reference.

The co-pending application discloses the feature of delivering focused advertisements, specifically prepared for each unique group identified, to the group alone out of a large numbers of target groups. Each target group receives the advertisements generated for them simultaneously in the bandwidth limited wireless mobile application space. A large number of characteristics of the individuals are weighted to define multiple groups with unique characteristics. The application further discloses the feature of combining these individual group characteristics with the advertisement campaign objectives and past behavioral patterns of the group members to generate focused advertisements for each group.

To define and deliver advertisements to any one of the target groups, unique characteristics of these groups must be identified. It should be possible to transmit multiple advertisements, directed at specific customer groups, during off-peak times where the advertisements are selectively downloaded by wireless handheld devices of the target group, and buffered or otherwise stored on the device.

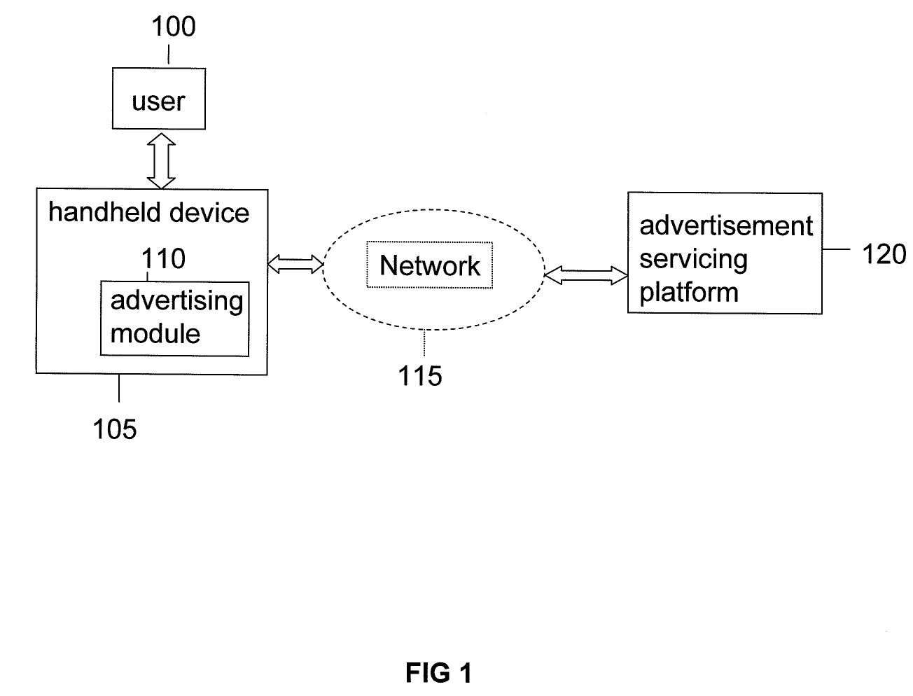

FIG. 1 is a block diagram that illustrates one embodiment of a system for implementing targeted advertisements on a handheld device 105. A user 100 can view advertisements on a handheld device 105, e.g. a computing platform configured to act as a handheld device such as a personal digital assistant, a digital media player, a handheld video game player, or a cellular telephone containing an advertising module 110. The advertisement servicing platform 120 generates advertisements, which are transmitted over the network 115.

In one embodiment, the network 115 can be implemented via wireless and/or wired solutions as indicated by the dashed lines in FIG. 1. In another embodiment, the network can be a local area network, a wide area network, the Internet.

The selective downloading can be achieved based on prior advertisement filtering that is input to the handheld device 105 from the advertisement servicing platform 120. Each viewing group filters and selects the ads specifically meant for that group only, thereby reducing the total buffering requirement on the handheld device 105. These ads are stored on the advertising module 110 and chosen based on the advertisement campaign for display during the allowed advertising time slots available to the wireless mobile operator during the viewing of the video data stream. This allows the same slot or advertising spot to be used for displaying different advertisements for different target groups by creating an addressable group-specific spot guide of metadata which is also transferred to the handheld device 105 by the advertisement servicing platform 120.

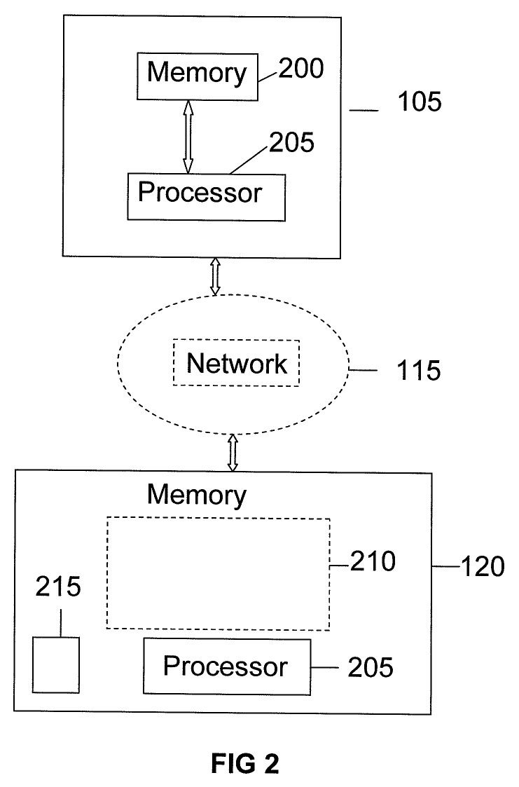

FIG. 2 is a simplified diagram illustrating an exemplary architecture in which the system for using targeted advertisements. The exemplary architecture includes a handheld device 105, an advertising service platform 120, and a network 115 connecting the handheld device 105 to the advertising servicing platform 120. The handheld device 105 is configured to include a computer-readable medium 200, such as random access memory or magnetic or optical media, coupled to an electronic processor 205. The processor 205 executes program instructions stored in the computer-readable medium 200.

The advertising servicing platform 120 includes a processor 205 coupled to a computer-readable medium 210. In one embodiment, the advertising servicing platform 120 is coupled to a secondary data storage element, such as a database 215 for storing the advertisements and target group criteria.

The advertising servicing platform 120 includes instructions for controlling the advertising module 110. In one embodiment, the handheld device 105 contains, in part, the customized application. Additionally, the handheld device 105 and the advertising servicing platform 120 are configured to receive and transmit electronic messages for use with the customized application.

One or more user applications are stored in memories 200, in memory 210, or a single user application is stored in part in one memory 200 and in part in memory 210.

The different groups to whom the advertisements are addressed and their associated metadata is provided based on the unique target group information developed from a wide variety of criteria. A hashing algorithm is used to identify individual members having similar characteristics to be included in a group. A hashing algorithm associates a unique identifier (key) with a hash value that is typically stored in a database. Hashing algorithms are an efficient way to store data because multiple keys are associated with the same hash value, which avoids duplicating records. By weighting each individual characteristic and using a hash function, the uniqueness of the group is maintained

The criteria for organizing unique target group information include the user's demographic information, known preferences, the user's handheld device usage, and the response history of the user to advertisements. The metadata for each target group is common to all users in that particular target group. The generation of the criteria that defines the target group also helps in the generation of focused advertisements to be supplied and stored on the handheld devices during any specific advertisement campaign.

This grouping can be expressed mathematically as:

Yn=Xb+Zu+E (1)

where Y defines the target group, X defines the fixed factors such as gender, age, ethnicity, etc. and Z defines the random factors such as value systems, viewing time preferences, etc. within the larger group.

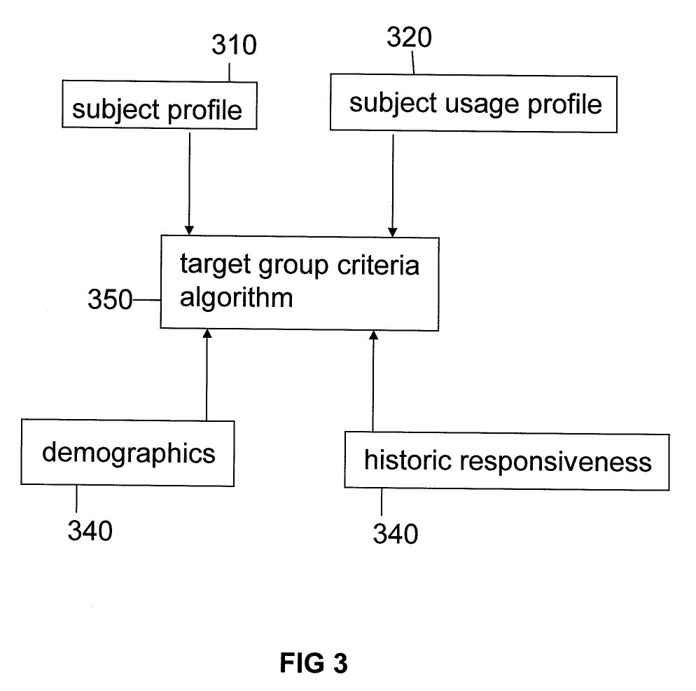

FIG. 3 is an illustration of the factors used to identify and group individual users into target groups using various criteria. The major categories that are used for identifying the target group include the areas of subject profile 310, subject usage profile 320, demographics 330, and historic responsiveness 340 of the members of the target group. These factors are given weights and combined using a suitable hashing algorithm to form the target group criteria 350 to generate the different target groups from the total population. Typical hashing algorithms are available to handle this operation and are well known. Examples of hashing algorithms will be apparent to one of ordinary skill in the relevant art.

The subject profile 310 consists of parameters like Sub-identifier, region, location, time zone, sex, age, ethnicity, and cell-identifier. The subject usage profile 320 consists of short message service (SMS), voice, multimedia service (MMS), web, commerce, wallet, i.e. payment methods, and social networking. The demographics 330 include location, social class, family relationships, income level, hobbies, etc. Lastly, the historic responsiveness 340 includes the groups' response to advertisements that are transmitted regardless of the specific characteristics. For example, the historic responsiveness 340 can include the frequency with which a user clicks on an advertisement displayed on a handheld device (click-through rate).

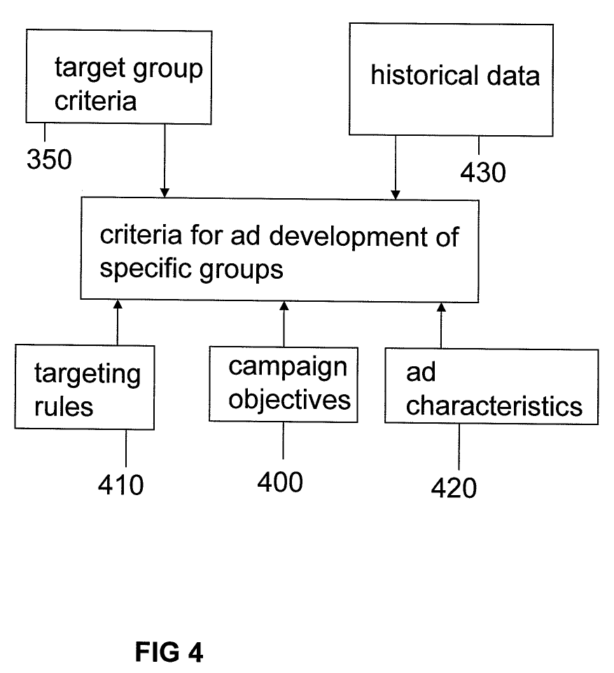

FIG. 4 illustrates the factors used to generate advertisement development criteria for specific target groups. The focused advertisements are designed to identify the individual members of a specific target group by using criteria that are specific to that target group 350.

The focused advertising development takes into account the target group criteria 350 and combines it with additional factors like the objectives 400 of the advertisement campaign, the rules for targeting 410 that are developed for the campaign, the required characteristics of the advertisement 420, and the historical data of the group members 430. A suitable hashing algorithm is used to generate these focused advertisement criteria 440 for each target group.

The objective 400 of each campaign identified by a campaign number consist of the duration of the campaign, region(s), demographics, time, e.g. peak, off-peak, advertisements (with identifiers), advertisement rotation, and advertisement fatigue, which is the gradual fall in the effect of the advertisement over time. Advertisement fatigue depends on factors like uniqueness of the advertisement, relevance of its message, advertisement frequency, complexity of the advertisement, etc.

The targeting rules 410 include contextuality, location, region, demography, advertisement insertion type, advertisement fatigue, replacement/tail (place advertisements based on what the user is searching for), and segment overlay.

The characteristics 420 of the advertisement include advertisement identification, interactivity, location, demographic mapping, content best fit, campaign number, advertisement rotation, insertion type, e.g. pre-roll, interstitial, or bumper, and multiple advertisements, e.g. associated advertisement identifications).

Historical data 430 consists of the content viewed by the members of the group, e.g. news, sports, soaps, etc., viewer-ship details, e.g. peak, off-peak, click thru rate, e.g. often, sometimes, never, channel switching during advertisements, e.g. often, sometimes, never, and advertisement responsiveness.

These data or characteristics are used to produce a hash function for easy access and security. These targeted advertisement criteria to specific groups can be defined in mathematical terms as:

Am=Fa+Rb+f(Yn) (2)

where F represents fixed factors specified for the advertisement campaign and R represents the random factors that impact the advertisement effectiveness including, but not limited to, ability of the customer to switch away from the advertisement display for known period, etc. and Yn represents the group characteristics of the individual target groups. Each of these factors has a weight associated with it in the equation.

The advertisement criteria itself is developed as indicated above using standard hashing algorithms. The advertisements that are paired with specific groups can be generated according to these criteria or can originate from another source, such as an advertiser, and be categorized according to the same characteristics that are used to group individuals into advertisement targeting groups. The appropriate algorithms will be apparent to one of ordinary skill in the relevant art.

By having response capability included in the advertisements, information can be collected on the effectiveness of the advertisement on target grouping for use in future advertisement development methodology to achieve high impact capability.

By developing advertisements focused on the characteristics of the members of each target group and allowing these to be provided selectively to the target groups in the time duration of available advertisement spots, the targeted advertisement campaigns can be made more effective and focused to achieve the desired results. The objectives 400 of an advertisement campaign are met by:
1. Identifying target groups within the user population based on their unique characteristics as explained earlier;
2. Developing focused advertisements for each target group identified that match the unique characteristics of the members of the target group; and
3. Delivering focused, personalized advertisements to each member of each target group.

Hence by developing a method for identifying target groups having similar characteristics within the wireless user population and developing and delivering focused advertisements to each group simultaneously, the effectiveness of the ad campaign can be improved substantially.

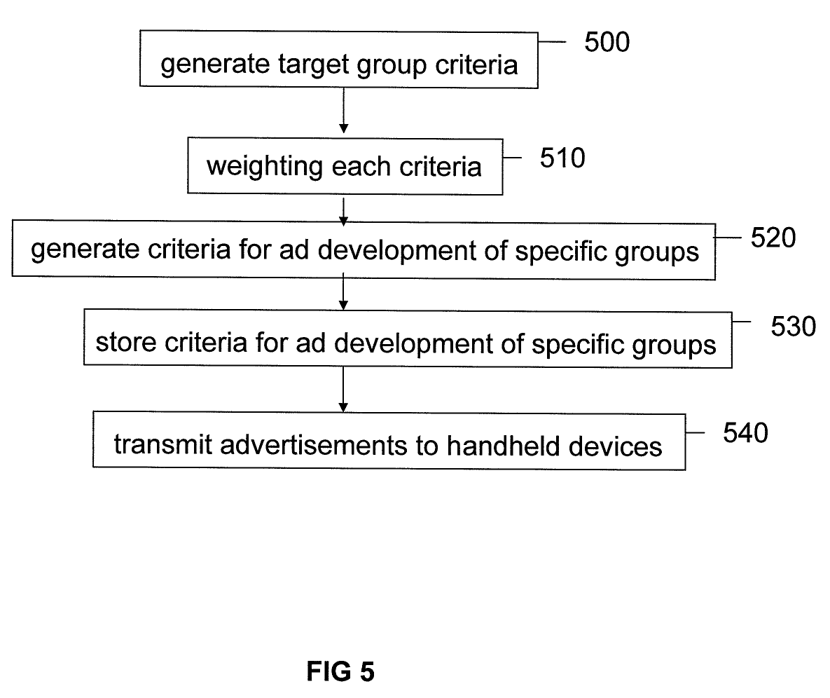

FIG. 5 is a flowchart that illustrates the steps of generating targeted advertising according to one embodiment of the invention. Target group criteria are generated 500 based on factors including, but not limited to, the subject profile 310, subject usage profile 320, demographics 330, and historic responsiveness 440. Each criteria is weighted 510 according to unique characteristics. The criteria for ad development of specific groups is generated 520 from a hash that includes the factors of a target group criteria 350, historical data 430, targeting rules 410, campaign objectives 400, and ad characteristics 420. The criteria for ad development of specific groups is stored 530, e.g. in a database 215. The advertisements are transmitted 540 to the handheld devices 105 of individuals that are within the target group.

As will be understood by those familiar with the art, the invention may be embodied in other specific forms without departing from the spirit or essential characteristics thereof. The inventions herein may be implemented in hardware, software, firmware, or any combination thereof. Likewise, the particular naming and division of the members, features, attributes, and other aspects are not mandatory or significant, and the mechanisms that implement the invention or its features may have different names, divisions, and/or formats. Accordingly, the disclosure of the invention is intended to be illustrative, but not limiting, of the scope of the invention, which is set forth in the following Claims.

1. A method for pairing advertisements with a group of handheld device users, the method comprising:
generating a target group criteria from at least one of the following factors:
a subject profile;
a subject usage profile;
demographics; and
historic responsiveness;
weighting each factor; and
generating a criteria for advertising development of specific groups from said target group criteria and at least one of the following additional factors:
a plurality of historical data;
a plurality of targeting rules;
a campaign objective; and
an advertising characteristic.

2. The method of claim 1, wherein the steps of generating criteria comprise using a hashing algorithm.

3. The method of claim 1, wherein said demographics comprise at least one of location, social class, family relationships, income level, and hobbies.

4. The method of claim 1, wherein said subject profile comprises at least one of Sub-identifier, region, location, time zone, sex, age, ethnicity, and cell-identifier.

5. The method of claim 1, wherein said subject usage profile comprises at least one of short message service, voice, multimedia service, commerce, payment methods, and social networking.

6. The method of claim 1, wherein said historic responsiveness comprises how many times a user clicks on an advertisement displayed on said handheld device.

7. An advertising servicing platform for generating criteria for advertising development for display on a handheld device comprising:
a module for generating a target group criteria from at least one of the following factors:
a subject profile;
a subject usage profile;
demographics; and
historic responsiveness; and
a module for generating a criteria for advertising development of specific groups from said target group criteria and at least one of the following additional factors:
a plurality of historical data;
a plurality of targeting rules;
a campaign objective; and
an advertising characteristic;
wherein said factors are weighted.

8. The apparatus of claim 7, wherein said campaign objective comprises at least one of a duration of said campaign, a region, a plurality of demographics, peak time, off peak time, advertisements, advertisement rotation, and advertisement fatigue.

9. The apparatus of claim 7, wherein said plurality of targeting rules comprises at least one of contextuality, location, region, demography, advertisement insertion type, advertisement fatigue, location of advertisements on a display, and segment overlay.

10. The apparatus of claim 7, wherein said advertising characteristic comprises at least one of advertisement identification, interactivity, location, demographic mapping, content best fit, campaign number, advertisement rotation, insertion type, and identification of associated advertisements.

11. The apparatus of claim 7, wherein said historical data comprises a type of content viewed by a user of said handheld device and a time of viewing said content.

12. A system for pairing advertisements with a group of handheld device users, said system containing program code stored on a computer-readable medium, the system comprising:
program code for generating a target group criteria from at least one of the following factors:
a subject profile;
a subject usage profile;
demographics; and
historic responsiveness;
program code for weighting each factor; and
program code for generating a criteria for advertising development of specific groups from said target group criteria and at least one of the following additional factors:
a plurality of historical data;
a plurality of targeting rules;
a campaign objective; and
an advertising characteristic.

13. The system of claim 12, wherein said criteria are generated using a hash function.

14. The system of claim 12, wherein said criteria are stored on a database.

15. The system of claim 12, further comprising program code for inserting said advertisement into media.

16. The system of claim 13, further comprising program code for transmitting said media to said handheld device.

17. The system of claim 16, wherein said handheld device comprises an advertising module for displaying said advertisements to said handheld device.

18. The system of claim 12, wherein said system further comprises program code for tracking a plurality of activities of said user on said handheld device.

19. The system of claim 12, wherein an advertiser provides advertisements for said advertising objectives.

20. The system of claim 12, wherein advertisements for said advertising campaign are generated according to the same criteria used to group said users.
